(19) United States
(12) Patent Application Publication
(10) Pub. No.: US 2009/0252933 A1
(43) Pub. Date: Oct. 8, 2009

(54) METHOD FOR DIGITALLY PRINTING ELECTROLUMINESCENT LAMPS

(75) Inventors: M. Benton Free, Saint Paul, MN (US); Daniel W. Hennen, Cottage Grove, MN (US); Gregory G. Jager, Woodbury, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 12/062,595

(22) Filed: Apr. 4, 2008

(51) Int. Cl. B32B 33/00; B05D 5/06; B05C 9/08

(52) U.S. Cl. 428/195.1; 427/66; 118/695

(57) ABSTRACT

A printer for digital printing in which ink is deposited in metered amounts on a substrate. The printer includes a wheel rotatable by a shaft of a motor, an idler disposed in a paint reservoir, and a segment of wire disposed around the wheel and the idler. A computer controls movement of the wire by controlling the rotation of the wheel. As the motor rotates the wheel, electroluminescent material contained within the paint reservoir coats the wire and is drawn by the wire in front of an air stream, which pulls the electroluminescent material from the wire and carries it toward the substrate to make an electroluminescent sign.

### BACKGROUND

Two conventional printing techniques include ink jet printing and screen printing. Ink jet printers work by depositing small droplets of ink in various colors, typically cyan, magenta, yellow and black, on a print medium or substrate to form a color image. Conventional thermal ink jet printing heads include several nozzles and thermal elements. Ink is expelled from the nozzles in a jet by bubble pressure created by heating the ink using the thermal elements while the nozzles and thermal elements are in close proximity. Ink jet print heads use relatively small orifices, valves, and nozzles for depositing the desired quantity and color of ink on the print medium. Therefore, very fine grade inks are required in which particle sizes of the pigments within the inks are kept to a minimum to help keep the orifices, valves, and nozzles of the ink system from becoming clogged.

In screen printing, ink is forced through a design-bearing screen onto the substrate being printed. The screen is made of a piece of porous, finely woven fabric stretched over a wood or aluminum frame. Areas of the screen are blocked off with a non-permeable material, a stencil, which is a negative of the image to be printed. The screen is placed on top of a piece of print substrate, often paper or fabric. Ink is placed on top of the screen, and scraper blade is used to push the ink evenly into the screen openings and onto the substrate. The ink passes through the open spaces in the screen onto the print substrate; then the screen is lifted away. The screen can be re-used for multiple copies of the image, and cleaned for later use. If more than one color is being printed on the same surface, the ink is allowed to dry and then the process is repeated with another screen and different color of ink. Screen printing requires use of inks having a relatively high viscosity to prevent all the ink from simply passing through the screen onto the print substrate.

Accordingly, a need exists for an improved apparatus and method for printing inks.

### SUMMARY

A method, consistent with the present invention, can be used to form a pattern on a substrate to make an electroluminescent sign. The method includes coating at least a portion of an exterior surface of a cable with an electroluminescent material, directing an air stream at the portion of the cable coated with the electroluminescent material, and electronically controlling advancement and position of the cable through the air stream such that a metered amount of the electroluminescent material is removed from the exterior surface of the cable and is deposited onto the substrate to form a pattern on the substrate.

An apparatus, consistent with the present invention, can deposit an ink on a substrate. The apparatus includes an electronically controllable drive mechanism and a structure associated with the drive mechanism and movable thereby. An electroluminescent material supply is in communication with the structure for depositing electroluminescent material on at least a portion of the structure. At least one fluid nozzle having at least one nozzle orifice is positioned and oriented for directing at least one jet of fluid toward at least a portion of the structure to remove an amount of the electroluminescent material from the structure and direct the amount toward a substrate. The movement of the structure relative to the at least one fluid nozzle substantially controls the amount of the electroluminescent material removed from the structure, and the amount of the electroluminescent material directed to the substrate to form a pattern on the substrate to make an electroluminescent sign.

### BRIEF DESCRIPTION OF THE DRAWINGS

The accompanying drawings are incorporated in and constitute a part of this specification and, together with the description, explain the advantages and principles of the invention. In the drawings,

FIG. 1 is a perspective view of one embodiment of a fluid delivery system or printer;

FIG. 2 is a side view of the fluid delivery system of FIG. 1; and

FIG. 3 is a diagram of a system to use the printer to print materials onto a substrate.

### DETAILED DESCRIPTION

### Printing System

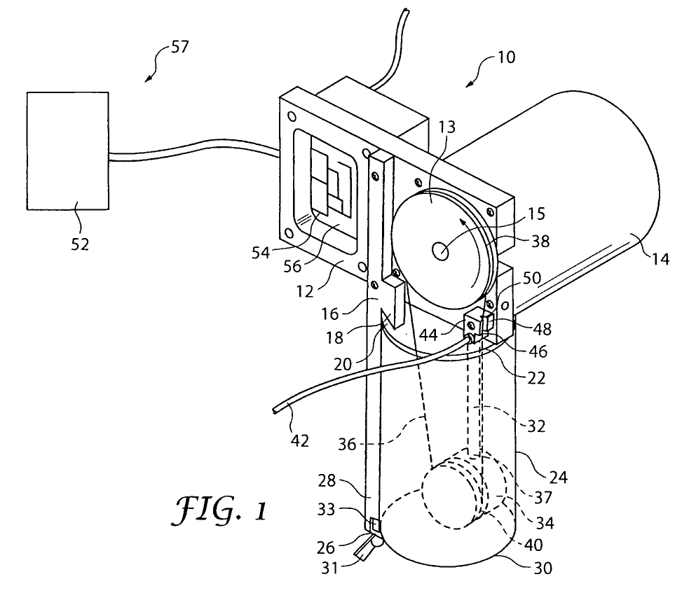

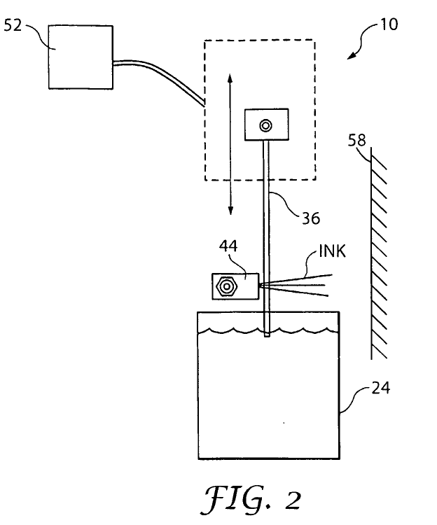

FIG. 1 is a perspective view of one embodiment of the fluid delivery system or printer, generally indicated at 10. FIG. 2 is a side view of the fluid delivery system or printer of FIG. 1. A pulley 13 having a circumscribing groove 38 defined therein is secured to a shaft 15 of a motor 14. An elongate frame member 32 is secured to frame or plate 12 and extends into a reservoir of ink 24. A rotatable or stationary guide 34 is attached to a distal end 37 of elongate frame member 32. Guide 34 is illustrated as a cylindrical, non-rotatable member having a groove 40 circumscribing guide 34 in which a wire cable 36 can slide during rotation of wheel 13. Alternatively, guide 34 can be implemented with a rotatable member. As used herein, the term “cable” or “wire” or “wire cable” or “elongate segment” is meant to include the use of a wire, a cable formed of multiple wires, a rod, a saw tooth wheel, or variations thereof. Wire cable 36 is disposed in groove 38 circumscribing the wheel 13 and in groove 40 circumscribing guide 34.

An elongate reservoir retaining member 16 is attached to plate 12 and includes a flange 18 defining a notch 20 between the flange 18 and elongate reservoir retaining member 16. Notch 20 is configured to receive a top lip 22 of ink reservoir 24. A bottom plate 26 is secured to a distal end 28 of elongate reservoir retaining member 16 with a threaded nut 31 that is threaded onto a threaded shaft 33. Threaded shaft 33 is secured to distal end 28 of elongate reservoir retaining member 16. Bottom plate 26 abuts against the bottom 30 of ink reservoir 24 and holds it between flange 18 and bottom plate 26.

An air supply hose 42 is secured to a nozzle body 44 and supplies air through a nozzle orifice 46 that is aimed at a portion of cable 36. A cable guide 48 defining a longitudinal slot 50 is positioned proximate nozzle orifice 46. Cable 36 rides within slot 50 and is thus held in relative position to nozzle orifice 46 so that air passing therethrough does not substantially move cable 36 from in front of nozzle orifice 46 or cause cable 36 to substantially vibrate. Slot 50 can alternatively include a small rotatable guide.

Rotation of shaft 15 may be controlled by a controller, generally indicated at 57. Any type of controller may be used. In one embodiment, the controller includes circuitry 54 in a module 56 that receives signals from a signal generating device 52, such as a microprocessor or other devices that can supply discrete signals to instruct selective rotation of the shaft 15 of the motor. Circuitry 54 receives a signal(s) from generating device 52 and rotates shaft 15 of the motor according to the signal(s).

In operation, ink contained in reservoir 24 is picked up by wire cable 36 and advanced by rotation of wheel 13, indicated by the arrow, in front of nozzle orifice 46. Fluid that is blown through nozzle orifice 46 disperses or pulls the ink from cable 36 toward the print medium. Depending on the viscosity of the ink in the reservoir, the cross-sectional diameter of cable 36, and the diameter of wheel 13, a relatively precise amount of ink can be dispensed. The ink is dispersed onto a substrate 58, as illustrated in FIG. 2.

The print head in system 10 can include alternative implementations, as shown in FIG. 1A in U.S. Pat. No. 5,944,893 and described in the corresponding text. For example, the print head can include a discontinuous wire, guide 34 can be rotatable, a spring tensioning mechanism can be used, and an air solenoid can be used to turn the air supply on and off.

The fluid delivery system or printer of the present invention is based on printer technology that is described in U.S. Pat. Nos. 5,944,893; 5,972,111; 6,089,160; 6,090,445; 6,190,454; 6,319,555; 6,398,869; and 6,786,971, all of which are incorporated herein by reference as if fully set forth.

As used herein, the term “ink” is meant to include any pigmented material, including, but not limited to, inks, dyes, paints, particle loaded suspensions, or other similarly pigmented liquids.

As used herein, the term “print medium” or “substrate” are meant to include any print medium known in the art, including but not limited to paper, plastic, polymer, synthetic paper, non-woven materials, cloth, metal foil, vinyl, films, glass, wood, cement, and combinations or variations thereof. The print medium or substrate can be a rigid material or a flexible material.

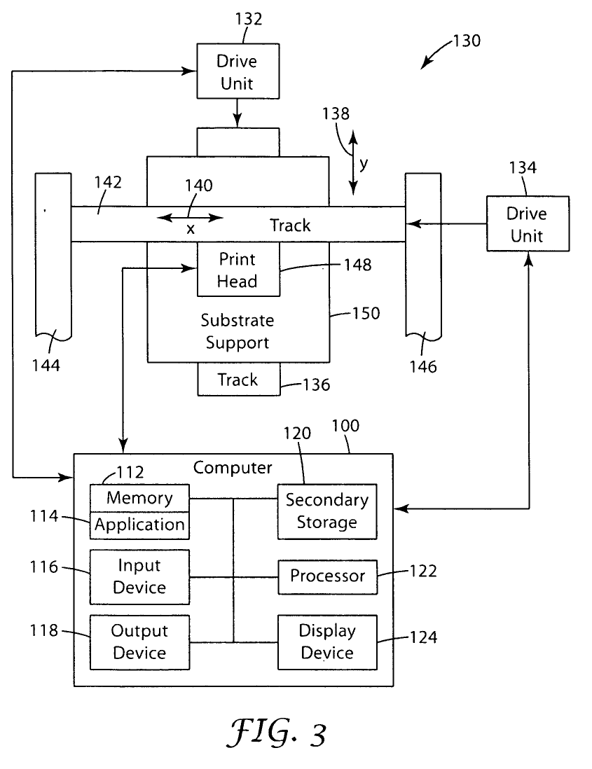

FIG. 3 is a diagram of a system 130 to use the printer to print ink onto a substrate. System 130 includes a print head 148 mounted on a track 142 supported by vertical posts 144 and 146, a wall, or other support. Print head 148 corresponds with printing system 10. A drive unit 134, using a motor, controls movement of print head 148 along track 142 in an x-direction as indicated by arrows 140. A substrate support 150 is located on a track 136, which would be supported by a vertical post, wall, or other support. A drive unit 132, using a motor, controls movement of substrate support 150 along track 136 in a y-direction as indicated by arrows 138. A substrate can be mounted or otherwise affixed to substrate support 150, and a line or pattern can be printed upon the substrate by print head 148. The configuration of the line or pattern is determined by the coordinated movement of print head 148 along track 142 and the substrate on substrate support 150 along track 136.

A computer 100, corresponding with controller 57 and used to implement controller 57, electronically controls print head 148 and drive units 132 and 134 for moving substrate support 150 and print head 148, respectively. Computer 100 can include, for example, the following components: a memory 112 storing one or more applications 114; a secondary storage 120 for providing non-volatile storage of information; an input device 116 for entering information or commands into computer 100; a processor 122 for executing applications stored in memory 112 or secondary storage 120, or as received from another source; an output device 118 for outputting information, such as information provided in hard copy or audio form; and a display device 124 for displaying information in visual or audiovisual form. Computer 100 can optionally include a connection to a network such as the Internet, an intranet, or other type of network.

Computer 100 can be programmed to control movement of print head 148 along track 142 and substrate support 150 along track 136. In particular, computer 100 can be programmed to electronically control movement of print head 148, via drive unit 134, in x-direction 140 laterally across a substrate on substrate support 150, and computer 100 can be programmed to electronically control movement of the substrate on substrate support 150, via drive unit 132, in y-direction 138 vertically with respect to print head 148. Computer 100 also controls print head 148, as described above, for movement of the wire and delivery of the ink from the wire to the substrate. Computer 100 can also be programmed to control an air solenoid in system 10. The use of tracks 136 and 142 for coordinated movement of substrate support 150 and print head 148, respectively, thus effectively functions as an X-Y stage for using the printer to print a wide variety of shapes and configurations of patterns, lines, or other elements. As an alternative, lines or patterns can be printed using one of the following techniques: coordinated movement of print head 148 in the y-direction and substrate support 150 in the x-direction; movement of print head 148 in both the x-direction and y-direction; or movement of substrate support 150 in both the x-direction and y-direction.

Computer 100 can also be programmed to control the printer for radial printing. In particular, a first orifice can direct an air jet at the wheel or wire to remove paint in a purely radial direction, while other orifices supplying air can be angled above the air jet created by the first orifice to help eliminate conical divergence of the paint as it is pulled from the surfaces of the wheel or wire.

### Printing Electroluminescent Lamps

As described above, the printer uses a wire to carry ink from the ink reservoir to the air jet, which blows the ink off the wire and onto the surface being coated. The quantity and quality of ink applied to the surface depends on the wire feed rate, rheologic properties of the ink, air flow, orifice geometry, and distance from the print head to the surface, among other things. The mechanism for this ink transport is shown in FIGS. 1 and 2. FIG. 3 illustrates an exemplary system for printing a line or pattern on a substrate using the printer.

Embodiments of the present invention include methods to digitally print electroluminescent signs using the printer described above. The printer is especially suited to digitally printing electroluminescent materials that cannot be digitally printed using standard techniques. The term “electroluminescent material” can refer to an electroluminescent material, an encapsulated electroluminescent material, or particles of electroluminescent materials. These materials can be suspended in a fluid possibly containing a binder or other materials.

The Luxprint electroluminescent system from DuPont Microcircuit Materials is a set of materials that, when screen printed in layers, creates electroluminescent lamps. That system includes compatible electroluminescent phosphors, dielectric compositions, carbon conductors, translucent conductors, and silver conductors. All of these materials are designed to be applied using standard screen printing techniques.

The printer described above provides for a technique to allow the user to digitally print multiple color electroluminescent signs and to control color blending and gradients currently not possible with screen printing. Digital printing also improves the versatility of the process, allowing for easy customization and quick changeover of printing patterns. In addition, the rear electrode for an electroluminescent sign can be printed using conductive ink provided into sections of the sign that can then be lit at different times, producing motion.

### EXAMPLE

The following three different color phosphors were obtained from DuPont

Microcircuit Materials Luxprint 8150B White High Brightness Electroluminescent Phosphor; Luxprint 8152B Blue-Green High Brightness Electroluminescent Phosphor; and Luxprint 8154B yellow-Green High Brightness Electroluminescent Phosphor. The Microencapsulated electroluminescent phosphors were diluted with diethylene glycol monoethyl ether acetate (Alfa Aesar, 99% purity) as a solvent. The diluted inks were loaded into the magenta, cyan, and yellow cans of the 3-color printer.

Images stored in JPG files were imported into the Photoshop program and modified to optimize the look of the image with the three available colors, and resulting JPG images were loaded into the driver software for the printer. The images were printed with the phosphors onto poly(ethylene terephthalate) (PET) coated with indium tin oxide.

The samples were then screen printed using a 157 mesh nylon screen with two layers of dielectric (Luxprint 8153 High K Dielectric Insulator), then a layer of carbon conductor (Luxprint 8144 Carbon Conductor). The resulting multi-layer prints were connected to an electroluminescent lamp driver (electroluminescent backlighting HV809 Demo Board, Mouser electronics part number 689-HV809 DB1).

1. A method of forming a pattern on a substrate, comprising:
providing a cable;
coating at least a portion of an exterior surface of the cable with an electroluminescent material;
directing an air stream at the at least a portion of the cable coated with the electroluminescent material; and
electronically controlling advancement of the cable through the air stream such that a metered amount of the electroluminescent material is removed from the exterior surface of the cable and is deposited onto the substrate to form a pattern on the substrate.

2. A method of digital printing to form a pattern on a substrate, comprising:
providing at least one paint injector, the at least one paint injector having a wheel rotatable by a shaft of a motor, an idler at least partially disposed in electroluminescent material contained in a reservoir, and a wire-like member disposed at least partially around the wheel and the idler;
advancing the wire-like member with the motor to apply a coating of the electroluminescent material to the wire-like member;
electronically controlling the position of the at least one paint injector relative to the surface and electronically controlling advancement of the wire-like member through a fluid stream; and
directing the fluid stream at the coated portion of the wire-like member, while controlling the position of the paint injector and the advancement of the wire-like member, thereby removing at least a portion of the electroluminescent material from an exterior of the wire-like member and depositing it onto a substrate to form a pattern on the substrate.

3. An apparatus for digitally printing a pattern on a substrate, comprising:
a support structure;
a carriage associated with and movable in at least one direction relative to the support structure;
an ink injector secured to the carriage, the ink injector comprising:
a motor having a rotatable shaft;
a wheel rotatable by the shaft of the motor;
an idler; and
an elongate segment disposed around at least a portion of the wheel and a portion of the idler and advanceable by the wheel, the elongate segment having a quantity of electroluminescent material coated onto at least a portion of the elongate segment;
at least one fluid nozzle positioned and oriented for directing a jet of fluid toward the at least a portion of the elongate segment to remove an amount of the electroluminescent material from the elongate segment and direct the amount toward a surface of a substrate to form a pattern on the substrate; and
a controller electronically connected to the motor for controlling rotation of the wheel and for controlling the position of the carriage relative to the support structure.

4. An apparatus for forming a pattern on a substrate, comprising:
an electronically controllable drive mechanism;
a structure associated with the drive mechanism and movable thereby;
an electroluminescent material supply in communication with the structure for depositing electroluminescent material on at least a portion of the structure; and
at least one fluid nozzle having at least one nozzle orifice positioned and oriented for directing at least one jet of fluid toward at least a portion of the structure to remove an amount of the ink electroluminescent from the structure and direct the amount toward a substrate,
wherein movement of the structure relative to the at least one fluid nozzle substantially controls the amount of the electroluminescent material removed from the structure, and wherein the amount of the electroluminescent material directed to the substrate forms a pattern on the substrate.

5. The apparatus of claim 4, wherein the structure comprises a wire.

6. The apparatus of claim 5, further including a biasing device associated with the wire to maintain tension in the wire.

7. The apparatus of claim 5, further including a mechanical metering device in contact with the wire for removing an amount of the electroluminescent material from the wire before the wire passes in front of the at least one orifice.

8. An electroluminescent article, comprising:
a substrate; and
an electroluminescent material digitally printed on the substrate in a particular pattern to form an electroluminescent sign.

9. The article of claim 8, wherein the substrate comprises a flexible material.
